(19) United States
(12) Patent Application Publication
(10) Pub. No.: US 2005/0263983 A1
(43) Pub. Date: Dec. 1, 2005

(54) Safety cable mount

(76) Inventor: Jonathan R. Saul, Erie, MI (US)

Correspondence Address: HARNESS, DICKEY & PIERCE, P.L.C., P.O. BOX 828, BLOOMFIELD HILLS, MI, 48303, US

(21) Appl. No.: 10/855,901

(22) Filed: May 27, 2004

(51) Int. Cl. B60P 3/06

(52) U.S. Cl. 280/457

(57) ABSTRACT

A safety cable mount for a trailer includes a bracket and a first aperture formed in the bracket. The first aperture facilitates attachment of a fixed-end of a first safety cable. A recess is formed in the bracket and selectively receives a free-end of the first safety cable.

### FIELD OF THE INVENTION

The present invention relates to safety cables for trailer hitches, and more particularly to a safety cable mount for trailer hitches.

### BACKGROUND OF THE INVENTION

Trailers are commonly used for towing any of a number of objects including boats, snowmobiles, recreational vehicles, and the like. Trailers are conventionally coupled to a towing vehicle via a tongue and hitch interface. In general, forward extending frame rails of a trailer include a tongue fixedly attached thereto. Traditional tongues include a ball socket that interfaces with a ball of the hitch for providing a primary connection therebetween. The ball and socket interface enables a degree of independent movement of the trailer, relative to the vehicle, for turning or other movement of the trailer relative to the vehicle.

A secondary, or safety, connection is also traditionally provided by at least one cable, but preferably a pair of cables. One end of each cable is anchored to the trailer and the free-ends are attached to a vehicle structure, such as a hitch portion, via a hook or some other selective attachment device. When the free-ends of the cables are not attached to the vehicle, they dangle and can drag. Dangling cables are not asthetically pleasing and can be a tripping hazard when manually moving the trailer.

### SUMMARY OF THE INVENTION

Accordingly, the present invention provides a safety cable mount for a trailer. The safety cable mount includes a bracket and a first aperture formed in the bracket. The first aperture facilitates attachment of a fixed-end of a first safety cable. A recess is formed in the bracket and selectively receives a free-end of the first safety cable.

In other features, the safety cable mount further includes a second aperture formed in the bracket. The second aperture facilitates attachment of a fixed end of a second safety cable. The recess selectively receives a free-end of the second safety cable.

In other features, the safety cable mount further includes a fastener that is secured through the first and second apertures. The fixed-end of the first safety cable is secured to the fastener. A fixed-end of a second safety cable is secured to the fastener.

In still another feature, the bracket includes a weld surface that facilitates welding of the safety cable mount to the trailer.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a safety cable mount according to the present invention;

FIG. 2 is a perspective view of an alternative safety cable mount according to the present invention;

FIG. 3 is a perspective view of a trailer hitch assembly including the safety cable mount of FIG. 2 using slots to secure safety cables thereto;

FIG. 4 is a perspective view of an alternative trailer hitch assembly including the safety cable mount of FIG. 2 using bolts to secure safety cables thereto;

FIG. 5 is a perspective view of another alternative safety cable mount according to the present invention; and

FIG. 6 is a perspective view of a trailer hitch assembly including the safety cable mount of FIG. 5.

### DETAILED DESCRIPTION OF THE PREFERRED EMBODIMENTS

The following description of the preferred embodiments is merely exemplary in nature and is in no way intended to limit the invention, its application, or uses. As used herein, the term cable is meant to include various types of similar structures known in the art including ropes, chains and the like.

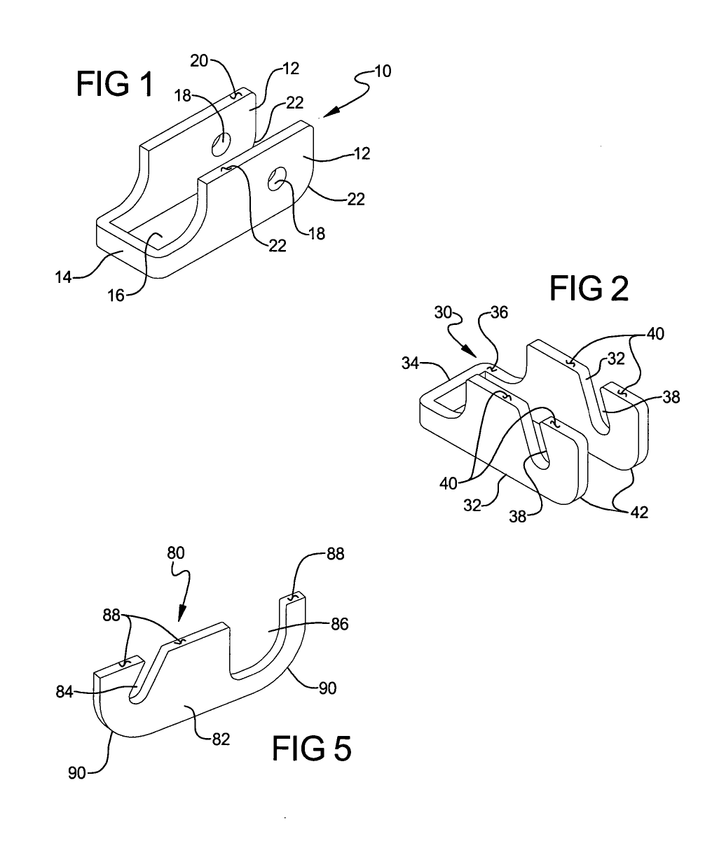

With particular reference to FIG. 1, a safety cable mount 10 is illustrated. The safety cable mount 10 includes parallel sides 12 that are bridged by a cross-member 14. Although the illustration of FIG. 1 shows the safety cable mount 10 as a single piece that is bent to form the parallel sides 12 and the cross-member 14, it is anticipated that the safety cable mount 10 can be made of multiple pieces that are joined together. The safety cable mount 10 includes a recess 16 formed above the cross-member 14 and partially formed in the parallel sides 12. Apertures 18 are formed through each of the parallel sides 12. The parallel sides 12 each include a mounting surface 20 and a chamfer or radius 22.

As described in further detail below, the recess 16 enables selective attachment of a free-end of a cable for storing the cable when not in use. The apertures 18 facilitate attachment of a fixed end of the cable to anchor the cable to the safety cable mount 10. The mounting surfaces 20 enable attachment of the safety cable mount 10 to a structure.

Referring now to FIG. 2, an alternative safety cable mount 30 is illustrated. The alternative cable mount 30 includes parallel sides 32 that are bridged by a cross-member 34. The safety cable mount 30 includes a recess 36 formed above the cross-member 34 and partially formed in the parallel sides 32. Slots 38 are formed through each of the parallel sides 32. The parallel sides 32 each include mounting surfaces 40 and a chamfer or radius 42. As described in further detail below, the recess 36 enables selective attachment of a free-end of a cable for storing the cable when not in use. The slots 38 facilitate attachment of a fixed-end of the cable to anchor the cable to the safety cable mount 30. The mounting surfaces 40 enable attachment of the safety cable mount 30 to a structure.

The safety cable mount 10 is generally implemented in instances where the safety cable is indirectly anchored to the safety cable mount 10. For example, and as described in further detail below, a bolt or other fastener is received through the apertures 18 and the safety cable is anchored to the fastener. The alternative safety cable mount 30 is generally implemented in instances where the safety cable is either directly or indirectly anchored to the safety cable mount 30. For example, and as described in further detail below, the safety cable can be directly mounted through one of the slots 38. Alternatively, a fastener is received through the slots 38 and the safety cable is anchored to the fastener.

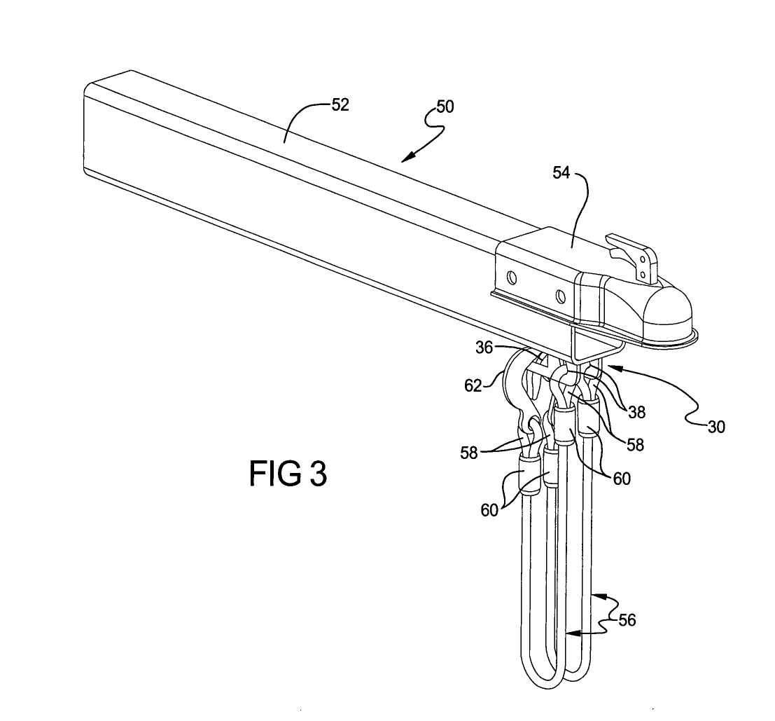

Referring now to FIG. 3, the safety cable mounts 10,30 are preferably designed for implementation with towed trailers for providing secondary (safety) connections. A portion of a trailer hitch assembly 50 is shown including a hollow, central frame rail 52 having a tongue mechanism 54 attached thereto. The tongue mechanism 54 is preferably of a type commonly known in the art, therefore a detailed description will not be presented here. The safety cable mount 10 or 30 can be secured to the trailer hitch assembly 50 by various means including, but not limited to, welding. The weld can be located along the entire length of the mounting surfaces 20,40 or a portion thereof. Although the safety cable mount 30 is illustrated in FIG. 3, it is appreciated that the safety cable mount 10 can also be implemented.

FIG. 3 illustrates direct attachment of safety cables 56 to the safety cable mount 30. More specifically, the safety cables 56 each include a length of multi-braid, coated cable having loops 58 formed at a fixed-end and a free-end. The loops 58 are formed by folding the cable back along its length and crimping, using crimps 60. Hooks 62 are attached to the free-ends of the safety cables 56. The fixed-ends are anchored to the safety cable mount 30 through the slots 38. The safety cables 56 are illustrated in a stored position whereby the hooks 62 are received through the recess 36 to hold the safety cables 56 in place and to prevent the safety cables 56 from dangling or dragging.

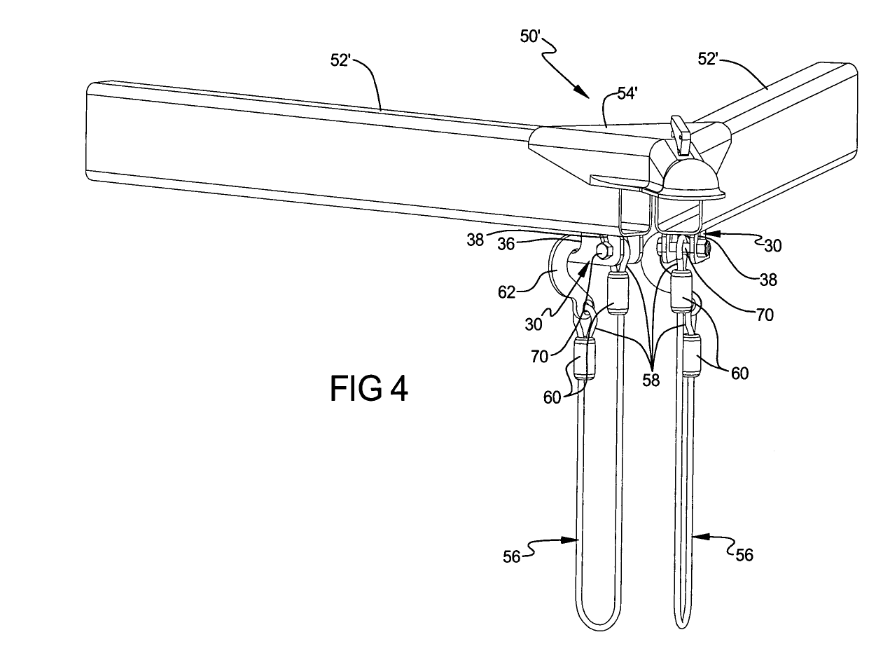

Referring now to FIG. 4, a portion of an alternative trailer hitch assembly 50′ is illustrated. The alternative trailer hitch assembly 50′ includes hollow frame rails 52′ attached in an A-type configuration by a tongue mechanism 54′. The safety cable mounts 30 are attached to bottom faces of the frame rails 52′. Although the safety cable mount 30 is illustrated, it is appreciated that the safety cable mount 10 can also be implemented. FIG. 3 illustrates indirect attachment of the safety cables 56 to the safety cable mount 30. Fasteners 70 are received through the slots 38 and the loops 58 at the fixed-ends of the safety cables 56 and are secured in place by nuts. The safety cables 56 are illustrated in a stored position whereby the hooks 62 are received through the recesses 36 to hold the safety cables 56 in place and to prevent the safety cables 56 from dangling or dragging.

Referring now to FIG. 5, another alternative safety cable mount 80 is illustrated. The alternative safety cable mount 80 includes a plate 82 having a slot 84 formed therein and a recess 86 formed therein. Mounting surfaces 88 are defined along an upper edge of the plate 82 and chamfers or radii 90 are formed along a bottom edge of the plate 82. The slot 84 facilitates direct attachment of the safety cable 56 and the recess 86 facilitates storage of the safety cable 56.

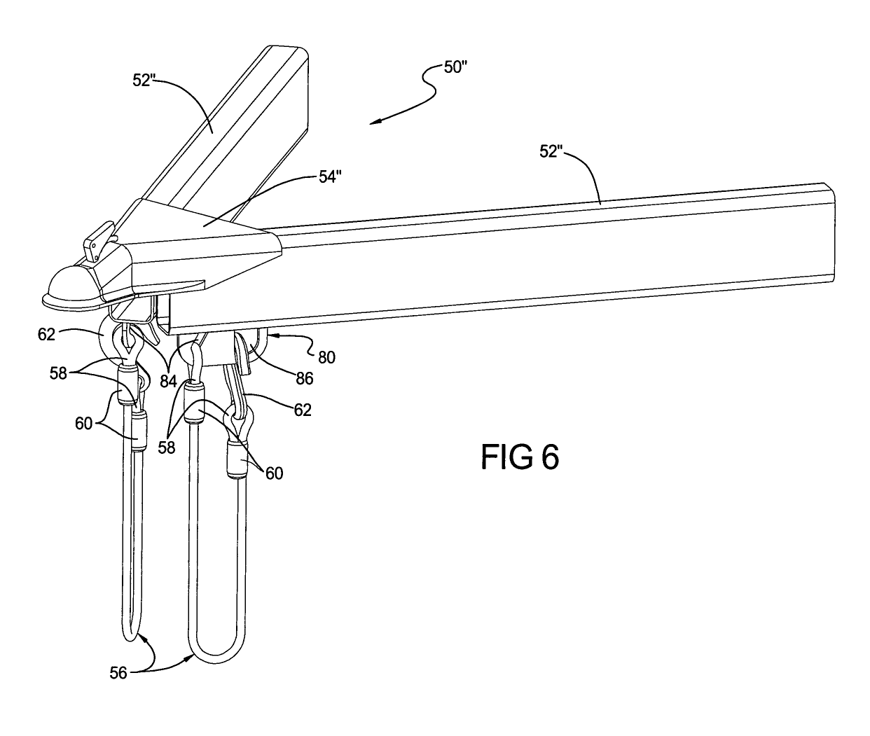

Referring now to FIG. 6, yet another alternative trailer hitch assembly 50″ is illustrated. The trailer hitch assembly 50″ is similar to that illustrated in FIG. 4. Therefore, like reference numbers are used to designate like components. The safety cable mounts 80 are attached to each of the frame rails 52″. The loops 58 on the fixed-end of the cables 56 are directly attached to the safety cable mounts 80 through the slots 84. The safety cables 56 are illustrated in a stored position whereby the hooks 62 are received through the recesses 86 to hold the safety cables 56 in place and to prevent the safety cables 56 from dangling or dragging.

The description of the invention is merely exemplary in nature and, thus, variations that do not depart from the gist of the invention are intended to be within the scope of the invention. Such variations are not to be regarded as a departure from the spirit and scope of the invention.

1. A safety cable mount for a trailer, comprising:
a bracket;
a first aperture formed in said bracket and which facilitates attachment of a fixed-end of a first safety cable; and
a recess formed in said bracket and which selectively receives a free-end of said first safety cable.

2. The safety cable mount of claim 1, further comprising a second aperture formed in said bracket.

3. The safety cable mount of claim 2, wherein said second aperture facilitates attachment of a fixed end of a second safety cable.

4. The safety cable mount of claim 3, wherein said recess selectively receives a free-end of said second safety cable.

5. The safety cable mount of claim 2, further comprising a fastener that is secured through said first and second apertures, wherein said fixed-end of said first safety cable is secured to said fastener.

6. The safety cable mount of claim 5, wherein a fixed-end of a second safety cable is secured to said fastener.

7. The safety cable mount of claim 1, wherein said bracket includes a weld surface that facilitates welding of said safety cable mount to said trailer.

8. A safety cable assembly for a trailer towed by a vehicle, comprising:
a first safety cable having a free-end selectively secured to said vehicle and a fixed-end secured to said trailer; and
a safety cable mount fixed to said trailer, comprising:
a bracket;
a first aperture formed in said bracket and which facilitates attachment of said fixed-end of said first safety cable; and
a recess formed in said bracket and which selectively receives said free-end of said first safety cable.

9. The safety cable assembly of claim 8, further comprising a second aperture-formed in said bracket.

10. The safety cable assembly of claim 9, further comprising a second safety cable having a free-end selectively secured to said vehicle and a fixed-end secured to said trailer, wherein said second aperture facilitates attachment of said fixed end of said second safety cable.

11. The safety cable assembly of claim 10, wherein said recess selectively receives a free-end of said second safety cable.

12. The safety cable mount of claim 9, further comprising a fastener that is secured through said first and second apertures, wherein said fixed-end of said first safety cable is secured to said fastener.

13. The safety cable mount of claim 12, wherein a fixed-end of a second safety cable is secured to said fastener.

14. The safety cable mount of claim 8, wherein said bracket includes a weld surface that facilitates welding of said safety cable mount to said trailer.

15. A safety cable mount for a trailer, comprising:
a U-shaped bracket having first and second sides and a cross-member;
apertures formed in said bracket, wherein at least one of said apertures facilitates attachment of a fixed-end of a first safety cable; and
a recess formed in said bracket and which selectively receives a free-end of said first safety cable.

16. The safety cable mount of claim 15, wherein another of said apertures facilitates attachment of a fixed end of a second safety cable.

17. The safety cable mount of claim 16, wherein said recess selectively receives a free-end of said second safety cable.

18. The safety cable mount of claim 15, further comprising a fastener that is secured through said apertures, wherein said fixed-end of said first safety cable is secured to said fastener.

19. The safety cable mount of claim 18, wherein a fixed-end of a second safety cable is secured to said fastener.

20. The safety cable mount of claim 1, wherein said bracket includes a weld surface that facilitates welding of said safety cable mount to said trailer.

21. A trailer that is selectively attachable to a vehicle, comprising:
a frame rail; and
a safety cable mount secured to said frame rail, said safety cable mount comprising:
a bracket;
a first aperture formed in said bracket and which facilitates attachment of a fixed-end of a first safety cable; and
a recess formed in said bracket and which selectively receives a free-end of said first safety cable.

22. The trailer of claim 21, further comprising a second aperture formed in said bracket.

23. The trailer of claim 22, wherein said second aperture facilitates attachment of a fixed end of a second safety cable.

24. The trailer of claim 23, wherein said recess selectively receives a free-end of said second safety cable.

25. The trailer of claim 22, further comprising a fastener that is secured through said first and second apertures, wherein said fixed-end of said first safety cable is secured to said fastener.

26. The trailer of claim 25, wherein a fixed-end of a second safety cable is secured to said fastener.

27. The trailer of claim 21, wherein said bracket includes a weld surface that facilitates welding of said safety cable mount to said trailer.
